(19) United States
(12) Patent Application Publication
(10) Pub. No.: US 2016/0029445 A1
(43) Pub. Date: Jan. 28, 2016

(54) UNIVERSAL INPUT LED DRIVER

(71) Applicant: LUXTECH, LLC, Philadelphia, PA (US)

(72) Inventors: Sean R. DARRAS, Philadelphia, PA (US); Ronald J. LENK, Woodstock, GA (US)

(73) Assignee: LuxTech, LLC, Philadelphia, PA (US)

(21) Appl. No.: 14/774,010

(22) PCT Filed: Mar. 13, 2014
(86) PCT No.: PCT/US14/25313

§ 371 Date: Sep. 9, 2015

Related U.S. Application Data
(60) Provisional application No. 61/786,955, filed on Mar. 15, 2013.

(51) Int. Cl. H05B 33/08

(52) U.S. Cl. CPC H05B 33/083; H05B 33/0809

(57) ABSTRACT

A universal AC-line input light emitting diode (LED) drive includes a rectifier, at least one LED connected to one output of the rectifier, a controllable element in series with the at least one LED, and a circuit for turning off the controllable element when the line voltage exceeds a reference voltage. The reference voltage is selected to produce the average current through the LEDs when the line voltage is nominally 120VAC, 240VAC, or 277VAC. Another circuit may also be provided for switching the reference voltage between at least two levels (e.g., two of 120VAC, 240VAC, or 277VAC) when an average line voltage exceeds a certain level.

### CROSS-REFERENCE TO RELATED APPLICATIONS

The present application claims priority to U.S. Provisional Patent Application No. 61/786,955, filed Mar. 15, 2013. The contents of that patent application are hereby incorporated by reference.

### FIELD OF THE INVENTION

The present invention relates to providing a universal AC-line input light emitting diode (LED) driver, and more particularly, to a driver that is very high efficiency and low parts count, that does not over-drive the LEDs at any voltage, and that reduces the amount of light flicker.

### BACKGROUND OF THE INVENTION

It is frequently desirable to power LEDs from the AC line. In North America, the AC line is nominally 120VAC or 277VAC; in other parts of the world, the AC line is nominally 240VAC. The actual line voltage may deviate from this nominal by ±10% or more on a regular basis.

LEDs typically have a forward voltage while conducting current of approximately 3V. This voltage varies somewhat as a function of the drive current and temperature, typically ±20%. However, LEDs, being diodes, need to be driven with a current rather than a voltage. For this reason, LEDs are frequently driven by switch-mode power supplies (SMPS), which convert the high-voltage AC line voltage to a low-voltage current.

However, SMPS tend to be expensive, and may have relatively a short lifetime compared with that of the LEDs they are driving. For this reason, some designs use a string of LEDs, with a sufficient number of LEDs in series in the string to present a forward voltage of approximately the line voltage. Some designs place the LED string directly across the AC line; however, since LEDs are unidirectional, the LEDs in this arrangement conduct only during half of each line cycle. Other designs first rectify the AC line and then apply the rectified voltage to the string of LEDs; in this arrangement, the LEDs conduct during both halves of the line cycle, thus providing double the light output.

However, such designs suffer from a number of problems. The most important of these is that as the line voltage increases above nominal, the LED current continues to increase; the increase may be so large that only a small voltage increase by the line may be enough to cause destructive current to flow through the LEDs.

A related problem is that such designs cannot operate from a universal input. They must be tailored to produce the right current (and thus light output) for a single line voltage. Operation at a higher line voltage, as would be desirable for a universal input voltage light, might cause failure.

Finally, the fact that the LEDs turn off every line cycle (during zero crossings of the AC line) produces visual flicker in the light. Some applications may find this flicker undesirable.

It would be desirable to have an AC drive circuit which controls the maximum current through the LEDs without affecting efficiency, and which can operate on universal line input. It would also be desirable that the AC drive circuit be inexpensive, have a long lifetime, and could reduce the amount of lighting flicker.

### SUMMARY OF THE INVENTION

The invention addresses the above and other needs in the art by providing an AC-line driver for LEDs that effectively solves the above-described primary and secondary problems. The invention provides an AC-line driver for LEDs that produces a certain current at one or more specific line voltages, while limiting the maximum current produced at other line voltages. It also provides for high efficiency, low cost and reduced lighting flicker.

In an exemplary embodiment, the invention includes a rectifier bridge and a string of LEDs attached to the bridge's output. The line voltage is compared with a reference voltage, and a transistor or current-limiter in series with the LEDs is turned off when the line voltage reaches a certain set-point. In one embodiment, the set-point is selected to produce the desired average current through the LEDs at a nominal line voltage and is selected to be less than the peak line voltage. In a preferred embodiment, the set-point is selected to produce the desired average current through the LEDs when the line voltage is 120VAC, 240VAC, or 277VAC.

In another exemplary embodiment, the invention further provides a circuit in which the average line voltage is also compared with a reference voltage. When the average line voltage reaches another certain set-point, the first reference voltage is changed such that the series transistor or current-limiter is turned off at a second line voltage level. In one embodiment, this second level corresponds to a second nominal line voltage, and the level is changed such that the same desired average current is produced through the LEDs as was produced at the first nominal line voltage. In a preferred embodiment, the second level is selected to produce the same average current through the LEDs when the line voltage is 277VAC as when the line voltage is 120VAC. In a further preferred embodiment, the second level is selected to produce the same average current through the LEDs when the line voltage is 240VAC as when the line voltage is 120VAC.

These and other characteristic features of the invention will become apparent from the following detailed description of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an AC-line input LED circuit in which the average current through a string of LEDs is set by turning off a series transistor at a specific voltage.

FIG. 2 is a diagram of an AC-line input LED circuit in which the average current through a string of LEDs is set by turning off a series current-limiter at a specific voltage.

### DESCRIPTION OF THE PREFERRED EMBODIMENTS

Reference will now be made in detail to the present preferred embodiments of the invention, an example of which is illustrated in the accompanying drawings. Wherever possible, the same reference numbers are used in the drawing and the description to refer to the same or like parts.

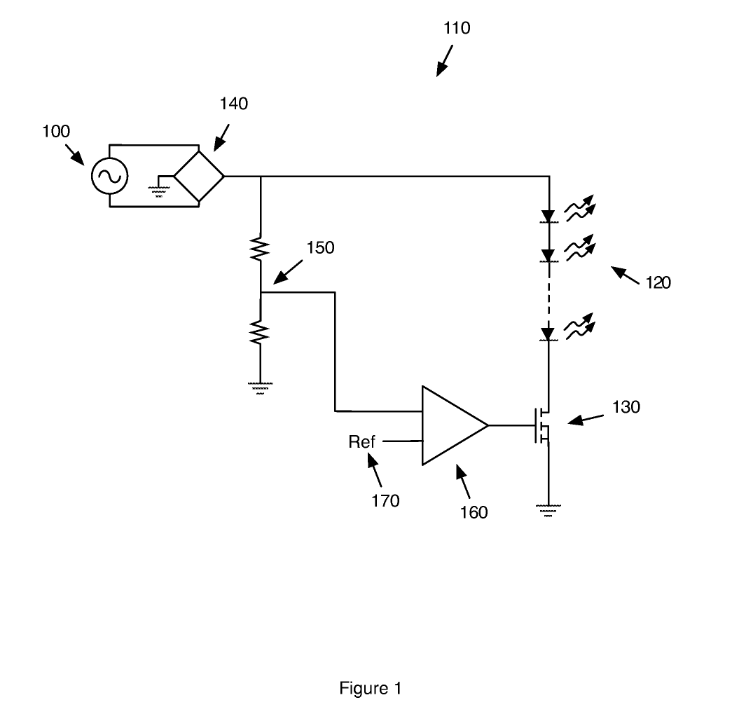

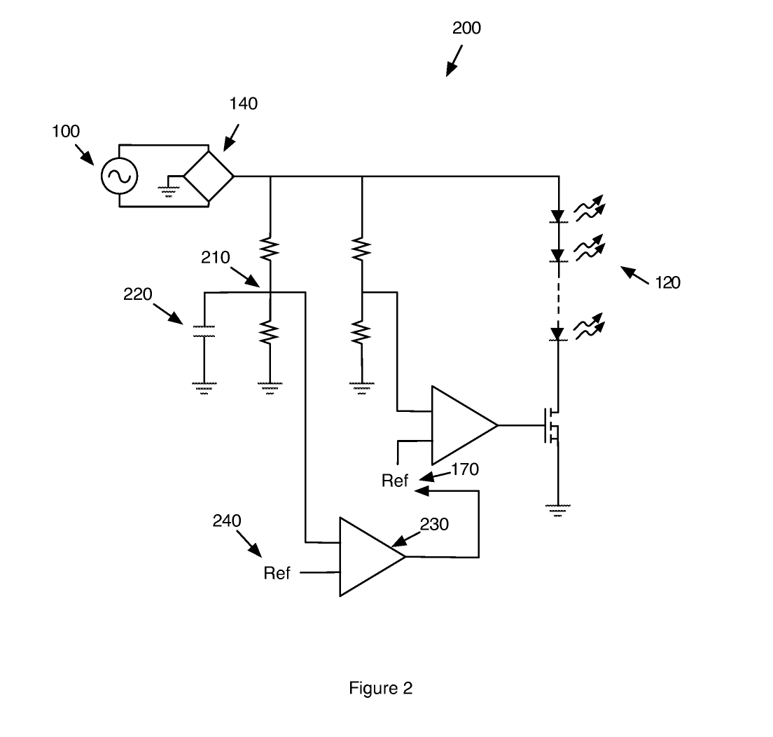

The invention will be described in detail below with reference to FIGS. 1-2. Those skilled in the art will appreciate that the description given herein with respect to those figures is for exemplary purposes only and is not intended in any way to limit the scope of the invention. All questions regarding the scope of the invention may be resolved by referring to the appended claims.

FIG. 1 is a diagram of an AC-line 100 input LED circuit 110 in which the average current through a string of LEDs 120 is set by turning off a series transistor 130 at a specific AC line 100 voltage. As shown in FIG. 1, the AC-line 100 is rectified by a diode bridge 140. The output voltage of the diode bridge 140 is fed to the string of LEDs 120, and this string of LEDs 120 is in turn in series with a transistor 130. Current from the diode bridge 140 goes through the string of LEDs 120 and through the transistor 130, and returns to the ground of the diode bridge 140.

The output voltage of the diode bridge 140 is also divided down by a resistor divider 150. The divided down voltage is compared by a comparator 160 with a reference voltage 170. While the divided down voltage is lower than the reference voltage 170, the comparator 160 holds the transistor 130 on. When the divided down voltage is higher than the reference voltage 170, the comparator 160 holds the transistor 130 off. The values of the resistor divider 150 and the reference voltage 170 are selected such that the average current during a line cycle through the string of LEDs 120 is set to a nominal value. In a preferred embodiment, the reference voltage 170 is selected such that the transistor 130 is off during a portion of the line cycle in which the line voltage is high. This doubles the flicker frequency of the string of LEDs 120, thus potentially reducing visible flicker.

When the AC-line voltage 100 is less than nominal, the average current through the string of LEDs 120 is less than nominal, since the string of LEDs 120 conducts for less time during the line cycle. When the AC-line voltage 100 is higher than nominal, the average current through the string of LEDs 120 is also less than nominal, since the divided down AC-line voltage 100 reaches the reference voltage 170 faster than at nominal, and thus the time during which the transistor 130 is on, and thus the conduction time of the string of LEDs 120, is also less.

In exemplary embodiments, the reference voltage set-point is selected to produce the desired average current through the LEDs when the line voltage is nominally 120VAC, 240VAC, or 277VAC.

FIG. 2 is a diagram of a universal AC-line input 100 LED circuit 200 in which the average line voltage is used to set the turn-off voltage of a series transistor 130 at different levels. As shown in FIG. 2, the output voltage of the diode bridge 140 is averaged and divided down by a resistor divider 210. The divided down voltage is averaged by the RC circuit or integrator formed by the resistor divider 210 and the capacitor 220. The time constant formed by the RC circuit formed by the resistor divider 210 and the capacitor 220 will preferably be several line cycles long. The averaged divided down voltage is compared by a comparator 230 with a reference voltage 240. While the averaged divided down voltage is lower than the reference voltage 240, the reference voltage 170 is held at a first level. When the averaged divided down voltage is higher than the reference voltage 240, the reference voltage 170 is held at a second level. Thus, when the average line voltage is at a first level, the string of LEDs 120 will have an average current flowing through them as set by the first level of the reference voltage 170. When the average line voltage is at a second level, the string of LEDs 120 will have an average current flowing through them as set by the second level of the reference voltage 170. In a preferred embodiment, the two levels of the reference voltage 170 will be set such that the average current flowing through the string of LEDs 120 will be the same at the two average line voltages. In between these two average line voltages, the average current flowing through the string of LEDs 120 will be less than at either of the two average line voltages. When the average line voltage is less than the first level, or greater than the second level, the average current flowing through the string of LEDs 120 will be less than that at the first level or second level respectively.

In exemplary embodiments, the second level is selected to produce the same average current through the LEDs when the line voltage is nominally 277VAC as when the line voltage is nominally 120VAC. In further exemplary embodiments, the second level is selected to produce the same average current through the LEDs when the line voltage is nominally 240VAC as when the line voltage is nominally 120VAC.

Those skilled in the art will appreciate that the LED driver circuits described herein efficiently control the maximum current through the LEDs and thus can operate on universal line input while effectively reducing the amount of lighting flicker. Also, since the components are inexpensive and long-lasting, the reliability of the LED driver circuit in accordance with the invention is significantly improved over prior art LED driver circuits.

It will be apparent to those skilled in the art that various modifications and variation can be made to the structure of the present invention without departing from the scope or spirit of the invention. For example, the transistor 130 may be replaced by a current-limiter or current sink. In view of the foregoing, it is intended that the present invention cover modifications and variations of this invention provided they fall within the scope of the following claims and their equivalents.

What is claimed is:

1. A line-voltage LED driver comprising:
a rectifier;
at least one LED connected to one output of said rectifier;
a controllable element in series with said at least one LED; and
a circuit for turning off said controllable element when the line voltage exceeds a reference voltage.

2. A line-voltage LED driver as set forth in claim 1, wherein said rectifier is a diode bridge rectifier.

3. A line-voltage LED driver as set forth in claim 1, wherein said at least one LED is at least one series string of LEDs.

4. A line-voltage LED driver as set forth in claim 1, wherein said controllable element connects said at least one LED to the other output of said rectifier.

5. A line-voltage LED driver as set forth in claim 1, wherein said controllable element is a transistor.

6. A line-voltage LED driver as set forth in claim 1, wherein said controllable element is a current limiter or current sink.

7. A line-voltage LED driver as set forth in claim 1, wherein said circuit for turning off said controllable element is a comparator.

8. A line-voltage LED driver as set forth in claim 1, wherein said reference voltage is selected to produce an average current through said at least one LED.

9. A line-voltage LED driver as set forth in claim 8, wherein said reference voltage is selected to produce the average current through the LEDs when the line voltage is nominally 120VAC, 240VAC, or 277VAC.

10. A line-voltage LED driver as set forth in claim 1, wherein said reference voltage is selected such that said controllable element is turned off during some portion of time surrounding the time during which the line voltage is high.

11. A line-voltage LED driver as set forth in claim 1, further comprising:
a circuit for switching said reference voltage between at least two levels when an average line voltage exceeds at least one certain level.

12. A line-voltage LED driver as set forth in claim 11, wherein said circuit for switching said reference voltage detects said average line voltage by means of an integrator.

13. A line-voltage LED driver as set forth in claim 12, wherein said circuit for switching said reference voltage is a comparator connected to an output of said integrator, said comparator providing said reference voltage to said circuit for turning off said controllable element.

14. A line-voltage LED driver as set forth in claim 11, wherein said at least two reference voltage levels are each selected to produce an average current through said at least one LED.

15. A line-voltage LED driver as set forth in claim 11, wherein said at least two reference voltage levels are selected such that said average current is the same at two different line voltages.

16. A line-voltage LED driver as set forth in claim 15, wherein said two different line voltages are selected from 120VAC, 240VAC, or 277VAC.
